(19) United States
(12) Patent Application Publication
(10) Pub. No.: US 2012/0202729 A1
(43) Pub. Date: Aug. 9, 2012

(54) GRAFFITI-CLEANING COMPOSITION

(75) Inventors: Arnaud Bourdette, Chelles (FR); Mourad Amara, Courbevoie (FR)

(73) Assignee: RHODIA OPERATIONS, Aubervilliers (FR)

(21) Appl. No.: 13/390,079

(22) PCT Filed: Jul. 30, 2010
(86) PCT No.: PCT/EP10/61118

§ 371 Date: Apr. 3, 2012

(30) Foreign Application Priority Data
Aug. 13, 2009 (FR) 0903946

(51) Int. Cl. C11D 3/20

(52) U.S. Cl. 510/109

(57) ABSTRACT

The present invention relates to a composition for cleaning graffiti, including a diester compound and surfactants.

The object of the present invention is a composition for cleaning graffiti comprising a compound of the diester type and surfactants.

In order to remove graffiti, various treatments are used. There exist preliminary treatments carried out before occurrence of the graffiti, aiming at facilitating the suppression of the graffiti after their occurrence, and treatments for suppressing graffiti, applied after occurrence of the graffiti. The treatments for suppressing graffiti are generally applied by cleaning with a liquid composition comprising a solvent.

For the preliminary treatments, the use of fluorinated polymers of the latex type is notably known. A product comprising such polymers, intended to be applied on building materials, is notably marketed under the name of Protectguard®. The use of other products is also known. Solvents are sometimes used as additives in the preliminary treatments.

The treatments for cleaning graffiti generally apply compositions comprising solvents. For example there exist commercial compositions based on N-methylpyrrolidone (NMP) or chlorinated solvents. The application of such solvents however has drawbacks: they may be dangerous for the user, they may pollute and/or require restrictive recovery, they are volatile organic compounds (VOCs) which may be harmful for the ozone layer and the regulations and use of which are restrictive. There exists a need for compositions having a better safety profile and/or a better environmental profile, notably with reduced VOCs.

The solvents of the dicarboxylic diesters type have a good environmental profile. For treating graffiti, linear dicarboxylic acid diesters are notably known, notably a solvent comprising a mixture of dimethyl adipate, dimethyl glutarate, and dimethyl succinate, for example marketed by Rhodia under the name of Rhodiasolv® RPDE. Document WO 2008/135409 describes the use of other branched diesters.

The addition of non-ionic surfactants to solvents of the linear dicarboxylic acid diester type, notably for graffiti-cleaning compositions was described in document WO 2008/042840.

However the compositions based on dicarboxylic acid diesters have limited efficiency. There exists a need for compositions with improved efficiency.

The present invention meets at least one of the needs mentioned above, by proposing a graffiti-cleaning composition comprising:

a) at least 50%, preferably at least 60% by weight of a solvent or a mixture of solvents comprising:
a1) a dicarboxylic add diester fitting the formula (I):

R¹—OOC—A—COO—R² (I)
wherein:
   the groups R¹ and R², either identical or different, represent a linear or branched, cyclic or non-cyclic, C₁-C₂₀ alkyl, aryl, alkylaryl, arylalkyl group.
   group A represents a linear or branched divalent alkylene group, and
a2) optionally at least one co-solvent,
   b) at least one non-ionic surfactant different from a polyalkoxylated terpene,
   c) optionally an anionic surfactant,
   d) optionally an acid, and
   e) optionally water.

According to an advantageous embodiment, the composition according to the invention comprises at least two different non-ionic surfactants b) preferably at least three different non-ionic surfactants b), and even more preferentially three different non-ionic surfactants b), all being different from a polyalkoxylated terpene.

The non-ionic surfactants b) are advantageously selected from polyalkoxylated triglycerides, preferably polyethoxylated castor oils, polyalkoxylated alcohols and mixtures thereof. They may also be of a different nature, as developed below in the description.

According to a preferred embodiment, the composition according to the invention further comprises an anionic surfactant c).

The graffiti-cleaning composition according to the invention may thus comprise:

a) at least 50%, preferably at least 60% by weight of a solvent or a mixture of solvents comprising:
a1) a dicarboxylic acid diester fitting formula (I):

R¹—OOC—A—COO—R² (I)
wherein:
   the groups R¹ and R², either identical or different, represent a linear or branched, cyclic or non-cyclic, C₁-C₂₀ alkyl, aryl, alkylaryl, arylalkyl group,
   group A represents a linear or branched divalent alkylene group, and
a2) optionally at least one co-solvent,
   b) at least one non-ionic surfactant different from a polyalkoxylated terpene,
   c) an anionic surfactant,
   d) optionally an acid, end
   e) optionally wafer.

The invention also proposes a graffiti-cleaning method comprising a step for applying the composition on a surface covered with graffiti.

The invention also proposes the use of the composition for cleaning graffiti.

### Definitions

In the present application, unless indicated otherwise, the amounts and/or ratios are given by weight.

In the present application, except if indicated otherwise, all the upper and/or lower limits of values indicate that the values are strictly less than or equal to the upper limit, and/or are strictly greater than or equal to the lower limit. The terms “comprised between” and “from . . . to . . . ” cover and disclose each of the limits individually, as well as the strictly lower values excluding the upper limit or the strictly greater values excluding the lower limit.

In the present application, unless indicated otherwise, the amounts of materials are considered as active material or dry material. In the present application, by <<surfactant>> is meant according to the reference regulations for ascribing customs codes (EEC Regulation 2658/87 and amendments), that the <<organic surfactants or surface agents>> are products which, when they are mixed with water at a concentration of 0.5% by weight at 20° C. and left to rest for one hour at the same temperature:
a) give a transparent or translucent liquid or a stable emulsion without separation of the insoluble material and,
b) reduce the surface tension of the water to 45 mN/m or less.

### a) Solvent or Mixture of Solvents

In the present application, by “mixture of solvents” is meant both a physical mixture prepared beforehand (premix) and a combination from separate sources, the mixture then being obtained during the preparation of the composition by mixing the solvents and the other ingredients.

The solvent or mixture of solvents may comprise a co-solvent a2). This is then a mixture of solvents. The weight ratio between a2) and a1) may be comprised between 5/50 and 50/5. It may for example be comprised between 5/50 and 30/70 or between 30/70 and 50/50 or between 50/50 and 70/30, or between 70/30 and 50/5.

a1) Dicarboxylic Acid Diester

It is noted that according to an alternative of the invention, the dicarboxylic acid diester may appear as a mixture of different dicarboxylic acid diesters of formula (I).

The groups R¹ and R², either identical or different may notably be selected from methyl, ethyl, n-propyl, isopropyl, benzyl, phenyl, n-butyl, isobutyl, cyclohexyl, hyexyl, n-hexyl, isooctyl, 2-ethylhexyl. They correspond to the alcohols of formulas R¹—OH and R²—OH, either identical or different.

In the present application, this dicarboxylic acid diester of formula (I) may be designated by “diester”, “particular diester”, or “diester used in the invention”.

If is possible to use one or more particular diesters. In the application, unless the presence of at least two particular diesters is explicitly mentioned, “a” particular diester may designate a single diester fitting formula (I) or a mixture or a combination of several particular diesters fitting formula (I).

The group A is a divalent alkylene group. The corresponding acid is the compound of formula HOOC—A—COOH. Mistakenly, the group A may be designated by the acid to which it corresponds.

According to a first alternative of the invention, A is a linear divalent alkylene group of formula (CH₂)ᵣ, wherein r is an average number comprised between 2 and 4 inclusive.

Preferably, A is selected so that the diester may be a mixture of adipate diesters (n=4) glutarate diesters (r+3), and succinate diesters (r=2).

Advantageously, the diester used in the present invention is selected from
dimethyl adipate.
a mixture of dimethyl adipate (for example from 9 to 17% by weight, as determined by gas chromatography), of dimethyl glutarate (for example from 59 to 67% by weight), and of dimethyl succinate (for example from 20 to 28% by weight), for example marketed by Rhodia under the name of Rhodiasolv® RPDE.
diisobutyl adipate.
a mixture of disobutyl adipate (for example from 9 to 17% by weight, as determined by gas chromatography), of diisobutyl glutarate (for example from 59 to 67% by weight), and of diisobutyl succinate (for example from 20 to 28% by weight), for example marketed by Rhodia under the name of Rhodiasolv® DIB.

According to a second alternative of the present invention, a dicarboxylic acid diester of formula (I), the group A of which is a branched divalent C₃-C₁₀ alkylene group, is used. In the present application, this diester of a dicarboxylic acid may be designated as “branched diester”.

In the branched diester used according to the invention, the group A may notably be a C₃, C₄, C₅, C₆, C₇, C₈, C₉ group or a mixture thereof. Preferably this is a C₄ group.

Group A is preferably selected from the following groups:
the group A_{MG} of formula —CH(CH₃)—CH₂—CH₂, (corresponding to 2-methyl glutaric acid)
the group A_{ES} of formula —CH(C₂H₅)—CH₂, (corresponding to 2-ethyl succinic acid), and
mixtures thereof.

Advantageously, the branched diester is the dimethyl ester of 2-methyl glutaric acid fitting the following formula:

CH₃—OOC—CH(CH₃)—CH₂—CH₂—COO—CH₃.

According to a preferred embodiment, the particular diester appears as a mixture comprising the diesters of dicarboxylic acids of the following formulae (I′), (I″) and optionally (II):

—R¹—OOC—A_{MG}—COO—R²(I′)

—R¹—OOC—A_{ES}—COO—R²(I″),

optionally R¹—OOC—CH₂)₄—COO—R² (II) (a diester of adiplc acid),

wherein:

A_{MG} is a group of formula —CH(CH₃)—CH₂—CH₂,

A_{ES} is a group of formula—CH(C₂H₅)—CH₂.

In these formulae (I′) (I″) and (II), the groups R¹ and R² may notably be methyl, ethyl or isobutyl groups.

According to a more preferred embodiment of the present invention, the mixture of diesters comprises:
from 70 to 95% by weight of the dicarboxylic acid diester of formula (I′), preferably the methyl diester.
from 5 to 30% by weight of the dicarboxylic acid diester of formula (I″), preferably the methyl diester, and
from 0 to 10% by weight of the dicarboxylic acid diester of formula (II), preferably the methyl diester.

A mixture of diesters, wherein the group A is branched, is marketed by Rhodia under the name of Rhodiasolv® IRIS. Such mixtures, as well as the suitable methods for obtaining them are notably described in documents WO 2007/101929; WO 2007/141404; WO 2008/009792; WO 2008/062058.

It is noted that according to an embodiment, the solvent a1) is a mixture of a solvent according to the first alternative (with one or more linear group(s) A) and of a solvent according to the second alternative (with at least one branched group A). This may for example be a mixture of the Rhodiasolv® IRIS and Rhodiasolv® RPDE products.

The composition may for example comprise from 60 to 80% by weight of the dicarboxylic acid diester.

a2) Co-Solvent

The co-solvent may notably be a polar solvent. It may notably be a compound selected from:
ethers of polydiols or their acetates, such as monoalkyl ethers of (poly)alkylene glycols, for example dipropylene glycol methyl ether, propylene glycol n-butyl ether or ethylene glycol monoethyl ether acetate,
dimethylsulfoxide,
alkylene carbonates, preferably ethylene carbonate,
ketones, preferably acetone, methylethylketone, cyclohexanone, gamma-butyrolactone, cyclopentanone, butanone,
dioxalanes, preferably 1,3-dioxolane or 1,3-dioxolane 2-one-4-methyl,
N-alkypyrrolidones, preferably N-methylpyrrolidone, or N-ethylpyrrolidone,
esters preferably alkyl formates such as ethyl formate, or alkyl acetates such as butyl acetate, or benzyl acetate, ethyl 3-ethoxy propionate, methyl levulinate,
phosphates or phosphonates, preferably trialkyl-phosphates such as triethylphosphate or dialkyl-alkylphosphonates such as dibutylbutyl-phosphonate,
ethers preferably anisole,
alcohols such as cyclohexanol, and
mixtures or combinations thereof.

It is noted that it is not excluded that a co-solvent belong to several of the categories mentioned above.

Advantageously, the diester may be combined with a (poly)diol ether or with one of its acetates, preferably dipropylene glycol methyl ether.

Advantageously, a diester of formula (I) wherein A is branched or linear may be combined with dipropylene glycol methyl ether.

The composition may for example comprise from 5 to 30% by weight of co-solvent.

According to an embodiment, the mixture of solvents does not comprise large amounts (less than 5% by weight, preferably less than 2.5%, preferably less than 1%, preferably none at all), of solvents of the aliphatic and/or aromatic hydrocarbon type, such as hydrocarbon cuts and/or paraffinic solvents (for example white spirit or products of the Isopar® or Solvesso® ranges from Exxon, Soltrol® from Shell), or a solvent of the NMP type, or a chlorinated solvent.

### b) Non-Ionic Surfactant

The composition comprises at least one non-ionic surfactant different from a polyalkoxylated terpene, advantageously at least two or even more preferentially three non-ionic surfactants different from polyalkoxylated terpenes. It is mentioned that such surfactants of the polyalkoxylated terpene type are notably described in documents WO 96/01245, WO 98/28249, WO 01/12765, and are marketed by Rhodia under the name of Rhodoclean®.

Non-ionic surfactants b) are known to one skilled in the art. As examples of non-ionic surfactants, mention may be made without any intention to be limited to them:
polyalkoxylated (ethoxylated, propoxylated, ethopropoxylated) phenols substituted with at least one C₄-C₂₀, preferably C₄-C₁₂ alkyl radical or substituted with at least one alkylaryl radical, the alkyl portion of which is a C₁-C₆ alkyl. More particularly, the total number of alkoxylated units is comprised between 2 and 100. As an example, mention may be made of polyalkoxylated mono-, di-, or tri-(phenylethyl) phenols, or polyalkoxylated nonylphenols. Among the ethoxylated and/or propoxylated, sulfated and/or phosphated di- or tristyrylphenols, mention may be made of ethoxylated di-(phenyl-1-ethyl)phenol, containing 10 oxyethylene units, ethoxylated di-(phenyl-1-ethyl)phenol, containing 7 oxyethylene units, sulfated ethoxylated di-(phenyl-1-ethyl)phenol, containing 7 oxyethylene units, ethoxylated tri-(phenyl-1-ethyl)phenol, containing 8 oxyethylene units, ethoxylated tri-(phenyl-1-ethyl)phenol, containing 16 oxyethylene units, sulfated ethoxylated tri-(phenyl-1-ethyl)phenol, containing 16 oxyethylene units, ethoxylated tri-(phenyl-1-ethyl)phenol, containing 20 oxyethylene unite, phosphated ethoxylated tri-(phenyl-1ethyl)phenol, containing 18 oxyethylene units,
polyalkoxylated (ethoxylated, propoxylated, ethopropoxylated) C₆-C₂₂ fatty acids or alcohols. The number of alkoxylated units is comprised between 1 and 60. The term of ethoxylated fatty acid includes both the products obtained by ethoxylation of a fatty acid with ethylene oxide and those obtained by esterification of a fatty acid with a polyethylene glycol,
polyalkoxylated (ethoxylated, propoxylated, ethopropoxylated) triglycerides of vegetable or animal origin. Thus, triglycerides are suitable, those derived from lard, tallow, groundnut oil, butter oil, cottonseed oil, flax oil, olive oil, palm oil, grape pip oil, fish oil, soya bean oil, castor oil, rapeseed oil, coprah oil, coconut oil and comprising a total number of alkoxylated units comprised between 1 and 60. The term of ethoxylated triglyceride designates both the products obtained by ethoxylation of a triglyceride with ethylene oxide and those obtained by transesterification of a triglyceride with a polyethylene glycol,
optionally polyalkoxylated (ethoxylated, propoxylated, ethopropoxylated) sorbitan esters, more particularly cyclized sorbitol esters with C₁₀-C₂₀ fatty acids such as lauric acid, stearic acid, or oleic acid, and comprising a total number of alkoxylated units comprised between 2 and 50.
ethylene oxide and propylene oxide block copolymers (generally of the three-block type).

According to a particular embodiment, a polyalkoxylated alcohol is used for example a polyalkoxylated fatty alcohol. The alcohol may typically be a C₈-C₁₈, preferably C₁₀-C₁₈, for example C₁₀-C₁₂ alcohol. The polyalkoxy units may typically be in an average number from 2 to 100. These may be units of the ethoxy type (often noted as EO since they may be obtained from ethylene oxide) and/or of the propoxy type (often noted as PO since they may be obtained from propylene oxide). The non-ionic surfactant may for example be a polyalkoxylated alcohol, preferably a polyethoxylated and/or polypropoxylated linear alcohol. In the case when the alkoxy units comprise both ethoxy and propoxy units, their distribution may be random or sequenced (with blocks), for example of the EO and then OP type. Polyalkoxylated alcohols which may be suitable for applying the invention, are for example marketed by Rhodia under the name of Antarox® or Rhodasurl®. Mention for example was made of the product Antarox® FM33.

A polyalkoxylated triglyceride which may be suitable for applying the invention, is for example a polyethoxylated castor oil, marketed by Rhodia under the name of Alkamuls®. For example mention is made of the product Alkamuls® RC and Alkamuls® EL719-E.

The composition may for example comprise from 0.05 to 5% by weight, preferably from 0.1 to 2.5%, preferably from 0.1 to 2%, by weight of the non-ionic surfactant.

### c) Anionic Surfactant

The composition may comprise an anionic surfactant. Surprisingly, it was found that the addition of such a compound even in a very small amount, may considerably improve the efficiency of the compositions.

Anionic surfactants are known to one skilled in the art. As examples of anionic surfactants, it is possible to mention, without intending to be limited thereto:
alkylsulfonic acids, arylsulfonic acids, optionally substituted with one or more hydrocarbon groups, and the acid function of which is partly or totally salified, such as C₈-C₅₀, more particularly C₈-C₃₀, preferably C₁₀-C₂₂ alkylsulfonic acids, benzenesulfonic acids, naphthalenesulfonic acids, substituted with one to three C₁-C₃₀, preferably C₄-C₁₆ alkyl groups, and/or C₂-C₃₀, preferably C₄-C₁₆ alkenyl groups
mono- or di-esters of alkylsulfosuccinic acids, including the linear or branched alkyl portion optionally substituted with one or more linear or branched C₂-C₄ hydroxylated and/or alkoxylated (preferably ethoxylated, propoxylated, ethopropoxylated) groups.
phosphate esters more particularly selected from those comprising at least one linear or branched saturated, unsaturated or aromatic hydrocarbon group comprising from 8 to 40 carbon atoms, preferably 10 to 30, optionally substituted with at least one alkoxylated (ethoxylated, propoxylated, ethopropoxylated) group. Further, they comprise at least one mono- or di-esterified phosphate ester group so that it is possible to have one or two free or partly or totally salified acid groups. The preferred phosphate esters are of the type: mono- and di-esters of phosphoric acid and of alkoxylated (ethoxylated and/or propoxylated) mono-, di- or tri-styrylphenol, or alkoxylated (ethoxylated and/or propoxylated) mono-, di-, or tri-alkylphenol, optionally substituted with one to two to four alkyl groups; those of phosphoric acid with an alkoxylated (ethoxylated or ethopropoxylated) C₈-C₃₀, preferably C₁₀-C₂₂ alcohol; of phosphoric acid with a non-alkoxylated C₈-C₂₂. preferably C₁₀-C₂₂ alcohol.
sulfate esters obtained from saturated or aromatic alcohols, optionally substituted with one or more alkoxylated (ethoxylated, propoxylated, ethopropoxylated) groups, and for which the sulfate functions appear in the free acid form, or are partly or totally neutralized. As an example, mention may be made of the sulfate esters more particularly obtained from saturated or unsaturated C₈-C₂₀ alcohols which may comprise 1 to 8 alkoxylated (ethoxylated, propoxylated, ethopropoxylated) units; sulfate esters obtained from polyalkoxylated phenol substituted with 1 to 3 saturated or unsaturated C₂-C₃₀ hydroxycarbon groups and wherein the number of alkoxylated units is comprised between 2 and 40; sulfate esters obtained from polyalkoxylated mono-, di- or tri-styrylphenol wherein the number of alkoxylated units varies from 2 to 40.

The anionic surfactants may be in the acid form (they are potentially anionic), or in a partly or totally salified form, with a counter-ion. The counter-ion may be an alkaline metal such as sodium or potassium, an earth alkaline metal such as calcium or further an ammonium ion of formula N(R)₄⁺ wherein R. either identical or different represents a hydrogen atom or a C₁-C₄ alkyl radical optionally substituted with an oxygen atom.

According to a particular embodiment, an optionally polyalkoxylated, phosphate ester is applied either in a salified form or not. Phosphate esters may be used notably those of the following formula:

[R″—(O—A″)_{y}·O]ₓ·P(═O)(OM)ₓ,

wherein:
M is selected from a proton, a cation or a mixture, for example of H⁺, K⁺, Na⁺
x′ and x″ are equal to 1 or 2 provided that the sum of x′ and x″ is equal to 3.
y, which is an average value, is comprised between 0 and 100, preferably between 1 and 15,
the groups R″ either identical or different represent a hydrocarbon radical comprising from 1 to 35 carbon atoms, and
the groups A″ either identical or different represent a linear or branched alkylene radical including 2 to 4 carbon atoms.

The groups R″, either identical or different, represent a C₁-C₃₅, preferably C₅C₂₀ alkyl, alkylaryl polyalkylaryl (polyarylalkyl)aryl group (the alkyl groups may be linear or branched, saturated or unsaturated). As regards polyalkoxylated compounds, these may be polyethoxylated compounds. The alkoxylation degree may notably be comprised between 0 and 100; preferably between 1 and 15.

More particularly the groups R″ may be linear or branched alkyl or alkenyl radicals bearing one or more ethylenic unsaturations, containing from 8 to 26 carbon atoms or 3 to 7 carbon atoms. As examples of such radicals, mention may notably be made of the radicals: stearyl, oleyl, linoleyl, and linolenyl. Further the radicals R″, either identical or not, may be aromatic radicals bearing alkyl, arylalkyl or alkylaryl substituants; these radicals comprising from 6 to 30 carbon atoms. As examples of such radicals, mention may be made i.a. of nonylphenyl, mono-, di- and tri-styrylphenyl radicals.

More particularly, the groups (O—A″), either identical or not, correspond to an oxyethylene, oxypropylene, oxybutylene radical or mixtures thereof. Preferably said group corresponds to an oxyethylene and/or oxypropylene radical.

Useful surfactants of the phosphate ester type are notably marketed by Rhodia under the names of Lubrhophos® and Rhodafac®. Mention is notably made of the product Rhodafac® RA600.

In particular, it is possible to apply phosphate esters with relatively short hydrocarbon chains R″, for example C₃-C₆ alkyls like those described in document U.S. Pat. No. 5,180,414. Such a product is notably marketed by Rhodia under the name of Geronol®CF/AR.

The composition may for example comprise from 0.01 to 5% by weight, preferably from 0.02 to 1%, preferably from 0.03 to 0.99%, of an anionic surfactant, preferably a phosphate ester.

d)Acid

The composition may notably comprise an acid. Without intending to be bound to any theory, it is believed that such a compound may notably contribute to breaking up the polymeric chains of the coating to be stripped off. The acid is preferably an organic acid. Such compounds are notably preferred for noxiousness and/or safety reasons, and/or for reasons of stability of the diester (resistance to hydrolysis). The composition may notably comprise from 1% to 5% by weight of acid. For the same reasons as those stated concerning the nature of the acid, it is preferable to apply moderate amounts.

As acids which may be used, mention is notably made of formic acid or acetic acid, lactic acid or oxalic acid.

e)Water

The presence of water may be voluntary; the water may contribute to activation of the cleaning. The presence of water may also be inflicted, as an impurity or byproduct of the ingredients of the composition or as a dilution medium of the ingredients. The composition preferably comprises at most 10% by weight of water, preferably at most 5% by weight of wafer. If it comprises water, the amount of water may for example be greater than or equal to 0.1% by weight.

### Other Ingredients

The composition may comprise other ingredients. These may be ingredients known to one skilled in the art and customarily used. These may for example be activators, thickeners, abrasive agents, pH control agents.

The activator is a molecule generally of small size which may open polymeric chains of the graffiti. All known and/or customarily used activators may be used. This may notably be an alcohol. Notably, mention is made of methanol, ethanol and isopropanol. The composition may notably comprise from 0.1% to 5% of activator, preferably alcohol.

The viscosity of the composition may be adjusted by means of a thickener. The desired viscosity may depend on the application method (the application method may depend on the viscosity of the composition). As an indication, if a thickener is used, it may be present in an amount ranging from 0.1 to 5% by weight.

All known and/or customarily used thickeners may be used. These may for example be derivatives of cellulose (ethylcellulose, bydroxypropylcellulose), xanthan gums or derivatives, guars or derivatives such as hydroxypropyl guars, carob or derivatives, alginates or derivatives, polyacrylates, starches or derivatives. It is notably possible to apply ether celluloses, for example the products marketed under the name of Methocel™ by Dow.

### Particular Features

According to an embodiment, which is particularly useful and/or efficient, the cleaning composition comprises:

a1) from 60 to 80% by weight of the dicarboxylic acid ester,
a2) from 5 to 30% by weight of propylene glycol n-butyl ether solvent,
b) from 0.05 to 5% by weight of a mixture of surfactants comprising two castor oils with different polyethoxylation degrees and a polyalkoxylated alcohol,
c) from 0 to 5% by weight of polyalkoxylated phosphate ester surfactant, in a salified form or not,
d) from 0 to 5% by weight of an acid, and
e) from 0 to 10% by weight of water.

By <<polyethoxylation degree>>, it will be meant that this is the average number of ethylene oxide units present on the polar portion of the surfactant.

According to an alternative embodiment, which is particularly useful and/or efficient, the cleaning composition comprises:

a1) from 60 to 80% by weight of dicarboxylic acid diester,
a2) from 5 to 30% by weight of dipropylene glycol methyl ether,
b) from 0.05 to 5% by weight of a surfactant of the polyalkoxylated alcohol type,
c) from 0.01 to 5% by weight of polyalkoxylated phosphate ester surfactant in a salified form or not,
d) from 0 to 5% by weight of an acid, and
e) from 0 to 10% by weight of water.

### Method of Preparing the Composition

The composition may be prepared by any suitable method, involving mixing of the different ingredients. According to a particular embodiment, it is possible to apply premixes of certain ingredients. Premixes may notably be products which are commercially available or intended to be marketed, it is notably possible to apply ready-to-use premixes for introduction into compositions (or “blends”) of the diester and of the co-solvent, of the diester and of the non-ionic surfactant, of the diester and of the anionic surfactant, of the diester and of the non-ionic surfactant and of the anionic surfactant, or of the diester, of the co-solvent and of the surfactant(s).

### Cleaning of Graffiti

Cleaning of graffiti is an operation for suppressing graffiti present on a substrate. Before the cleaning, a degradation of the substrate has therefore occurred by graffiti. However the use of the composition of the invention is not excluded in a preliminary treatment, promoting subsequent suppression of the graffiti. It is noted that the graffiti may be suppressed totally or partly. By partial suppression is meant that only portions of the substrate have been cleaned (graffiti suppressed on only one portion of the surface) and/or that the visibility of the graffiti has been attenuated.

The graffiti may notably be ink-based graffiti, for example made with a pen, or paint-based graffiti for example made with a spray can, a brush or a roller.

The substrate may notably be a building material. In the present application, by building material is meant any large size element which may be found in the public domain (interiors of buildings accessible to a large number of persons including companies, restaurants, outer portions of buildings accessible to third parties, transportation means, floors, urban furniture, etc.,) as opposed to the private domain (portions of apartments or houses non-accessible to third parties).

The substrate, preferably a building material, may for example be in one of the following materials:
a ceramic, preferably tiling for example of the enameled stoneware type,
a material with a hydraulic binder, preferably cement, mortar, or concrete,
wood,
terracotta, for example bricks, tiles, terracotta tiles, or,
stone, preferably porous stone,
a metal panel, optionally covered with a coating such as paint, for example an epoxy or polyurethane paint, for example the body of a railway carriage, a truck, a car or a van.

These may notably be outer surfaces of the type: frontages, dressed stone, balusters, cornices, statues, joints, lintels and paintings, apertures, facings, bases, balconies, terraces, staircases, paths and pedestrian alleys, fences, growers, parking spaces, alleys suitable for vehicles, garage floors, swimming pool sundecks, fountain surroundings, barbecues, roofing, chimneys.

This may notably be a porous material such as limestones, marbles, stoneware, granites, slates, terracotta materials (tiles, bricks, terracotta tiles), concretes, coatings (MPC), artificial stones, bitumen.

The invention proves to be particularly advantageous for substrates in a porous material, such as for example limestones, marbles, sandstones, granites, slates, terracotta materials (tiles, bricks, terracotta tiles), concretes, coatings (MPC), artificial stones, bitumen, or for possibly coated metal substrates.

A useful method for cleaning graffiti may notably comprise the following steps:

step 1); apply the composition onto the graffiti
step 2): optionally leave it to work
step 3): total or partial suppression of the composition for example by wiping and/or washing and/or rinsing with water.

For step 1), the composition may be applied on the graffiti with any suitable means, for example by spraying, applying with a brush or a roller, a sponge or a piece of cloth. For applications with a brush or roller, the application of relatively viscous compositions may be preferred. The viscosity may be adjusted with thickeners.

For step 2), the action time may depend on the nature of the graffiti, on the nature of the substrate, and/or on the required cleaning standard. The useful and effective action time is generally directly determined by the user.

After or during the application, the graffiti may be rubbed in order to suppress it. The spraying force may however be sufficient for at least partial disappearance of the graffiti. The suppression operation may be repeated if this is useful.

For step 3), the composition may be suppressed by wiping or rinsing or washing the substrate, for example in order to remove the resultant solute and/or for removing possible runoffs. This operation may be applied with a cloth, with a water jet, or with a pressurized sprayer, such as an appliance of the Kärcher® type.

Other details or advantages of the invention will become apparent upon considering the examples which follow.
In the examples, the letter C indicates a comparative example.

### EXAMPLE 1

### Graffiti-Cleaning Compositions

The following compositions are made by mixing (the amounts are indicated in parts of materials as such) as indicated in Table 1 below:

TABLE 1

| | Exam- | Exam- | Exam- | Exam- | Exam- |
|---|---|---|---|---|---|
| | ple | ple | ple | ple | ple |
| | 1.1 | 1.2 | 1.3 | 1.4 | 1.5 |
| Rhodiasolv ® | 61.5 | 61.5 | 61.5 | / | 61.5 |
| IRIS, Rhodia | | | | | |
| Rhodiasolv ® | 15 | 15 | 15 | 76.5 | 15 |
| RPDE, Rhodia | | | | | |
| Dipropylene | 20 | 20 | 20 | 20 | 20 |
| glycol methyl | | | | | |
| ether | | | | | |
| (Dowanol ® DPM, | | | | | |
| Dow) | | | | | |
| Lactic acid | 3.5 | 3.5 | 3.5 | 3.5 | 3.5 |
| Antarox ® FM33, | 0.5 | 0.5 | 0.5 | 0.5 | 0.5 |
| Rhodia | | | | | |
| Geronol ® CF/AR, | / | 0.1 | 0.1 | 0.1 | / |
| Rhodia | | | | | |
| Alkamuls ® RC, | / | / | 0.5 | 0.5 | 0.5 |
| Rhodia | | | | | |

### EXAMPLE 2

### Graffiti-Cleaning Efficiency Test on a Metal Substrate

A graffiti cleaning test is applied with different compositions on metal specimens coated with an epoxy coating. These specimens typically simulate metal panels of a railway carriage or a motor vehicle.

A graffiti is simulated on the surface by means of orange paint, available under the reference of Alien Art Concept, MTN.

The paint is left to dry for one night at 50° C.

0.5 mL of formulation are applied on the surface to be cleaned. One waits for 1′30″ and one wipes with a precision wiper Kimwipe®. The percentage of clean surface is evaluated visually.

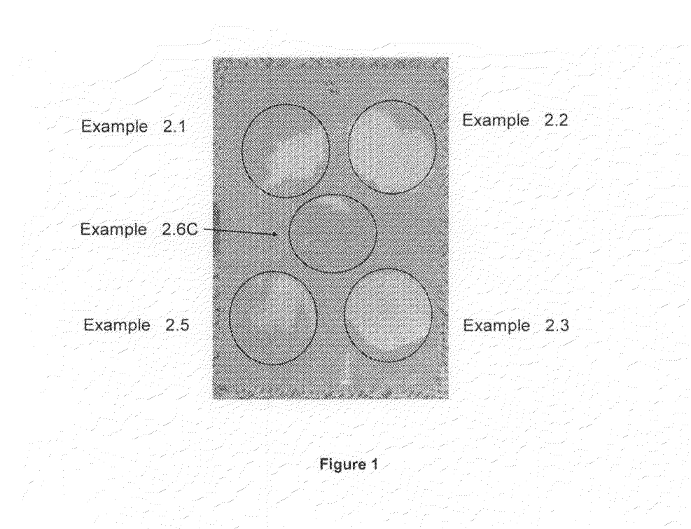

The results are also shown in FIG. 1 (the pale portions correspond to the clean portions).

The results are shown in the following Table 2:

TABLE 2

| | Example | | | | | |
|---|---|---|---|---|---|---|
| | 2.1 | 2.2 | 2.3 | 2.4 | 2.5 | 2.6C |
| Tested | 1.1 | 1.2 | 1.3 | 1.4 | 1.5 | Commercial |
| composition | | | | | | NMP-based |
| | | | | | | composition |
| Clean | 50% | 90% | 90% | 70% | 40% | 5% |
| surface | | | | | | |

It is seen that the compositions 1.1 to 1.5 according to the invention are much more efficient in terms of graffiti-cleaning than the NMP-based one, which is further toxic.

### EXAMPLE 3

### Graffiti-Cleaning Formulations

The formulations below indicated in Table 3 were made (the amounts are indicated in mass percent relatively to the total weight of the composition).

TABLE 3

| Ingredients | 3.1C | 3.2C | 3.3C | 3.4 | 3.5 | 3.6 | 3.7 |
|---|---|---|---|---|---|---|---|
| Rhodiasolv ® | 100 | | 70 | 69.7 | 69 | 68.3 | 54.2 |
| IRIS, Rhodia | | | | | | | |
| Rhodiasolv ® | | 100 | 30 | 29.8 | 29.5 | 29.2 | 23.3 |
| RPDE, Rhodia | | | | | | | |
| Propylene glycol | — | — | — | — | — | — | 20 |
| butyl ether | | | | | | | |
| Antarox ® FM | — | — | — | 0.5 | 0.5 | 0.5 | 0.5 |
| 33, Rhodia | | | | | | | |
| Alkamuls ® | — | — | — | — | 1 | 1 | 1 |
| EL719-E, Rhodia | | | | | | | |
| Alkamuls ® RC, | — | — | — | — | — | 1 | 1 |
| Rhodia | | | | | | | |

### EXAMPLE 4

### Graffiti-Cleaning Efficiency Test on a Metal Substrate

The study of the efficiency of the graffiti-cleaning formulations above was conducted by measuring transmittance.

Transmittance is a measurement which allows the measurement of the intensity loss of a light ray covering a certain distance within a formulation. In this formulation, a support coated beforehand with paint is immersed. The paint will be gradually solubilized, the pigments will color the formulation, which will attenuate the light intensity of a ray which has traveled through it, and thereby decrease transmittance.

In order to carry out the measurements, the following procedure is applied:

A metal plate, with a surface of 7.5*2.5 cm², is covered by spraying with a paint film (paint Montana Colors, 2G, black). The paint is dried for 24 hours at room temperature. Each plate is immersed in 40 ml of the formulation to be tested. The time-dependent change in the transmittance is measured by means of a Metrohm probe connected to a turbidimeter of the same brand, with reference 662 Photometer. The wavelength used during the measurement is 650 nm. For each measurement, a stirring blade homogenizes the formulation at 300 rpm. As soon as the metal plate is immersed in the formulation, the measurement starts. It stops when the transmittance value is stable for at least 1 min.

### Exploitation of the Transmittance Measurement:

The obtained curves are exploited by measuring the absolute value of the slope at the moment when the transmittance value starts to decrease. This value characterized the affinity which the solvents and/or the surfactants have for paint. The cleaning efficiency may thereby be evaluated and compared.

A reference is used for each measurement. This formulation 3.3C corresponding to a Rhodiasolv® IRIS/Rhodiasolv® RPDE mixture (70/30 by weight). In order to compare the obtained results, the ratios are compared: Formulation slope/Formulation slope of reference 3.3C (S formulation/S ref.).

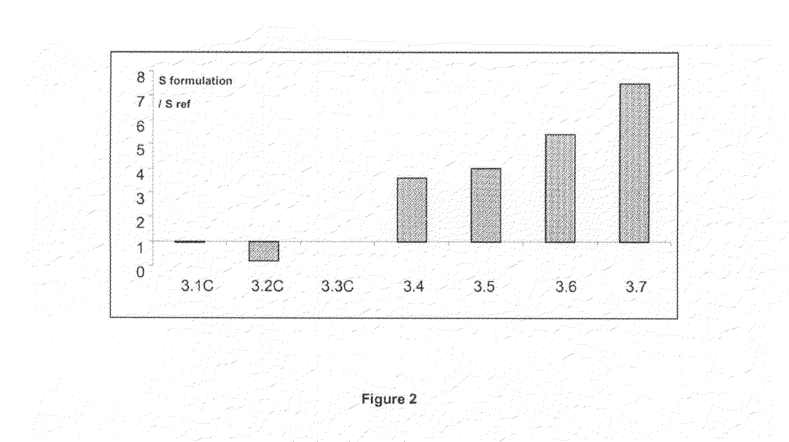

The obtained results are shown below in Table 4 as well as in FIG. 2:

TABLE 4

| | Formulation | | | | | | |
|---|---|---|---|---|---|---|---|
| | | | 3.3C | | | | |
| | 3.1C | 3.2C | (reference) | 3.4 | 3.5 | 3.6 | 3.7 |
| S formulation/ | 0.95 | 0.2 | 1 | 3.6 | 4 | 5.4 | 7.5 |
| S ref | | | | | | | |

It is seen that the formulations of the invention have a considerably larger graffiti-cleaning efficiency than those of the comparative formulations.

1-19. (canceled)

20. A method tor removing graffiti comprising:
applying to said graffiti a composition comprising:
a) at least 50% by weight of a solvent or a mixture of solvents comprising:
a1) a dicarboxylic acid diester of formula:
R¹—OOC—A—COO—R²
wherein:
the groups R¹ and R², which are identical or different, comprises a linear or branched, cyclic or non-cyclic C₁-C₂₀ alkyl aryl, alkylaryl, or arylalkyl group, and
group A comprises a linear or branched divalent alkylene group, and
a2) optionally at least one co-solvent,
b) at least one non-ionic surfactant that is not a polyalkoxylated terpene,
c) optionally an anionic surfactant,
d) optionally an acid, and
e) optionally water.

21. The method of claim 20, wherein the composition comprises at least two non-ionic surfactants, neither of which comprises a polyalkoxylated terpene.

22. The method of claim 20, wherein, the composition comprises at least three, non-ionic surfactants, none of which comprises a polyalkoxylated terpene.

23. The method of claim 20, wherein the non-ionic surfactant comprises a polyalkoxylated triglyceride, a polyalkoxylated alcohol or a mixture thereof.

24. The method of claim 23, wherein the polyalkoxylated triglyceride comprises a polyethoxylated castor oil.

25. The method of claim 20, wherein the composition comprises an anionic surfactant.

26. The method of claim 25, wherein the anionic surfactant comprises an optionally polyalkoxylated phosphate ester in a salified or non-salified form.

27. The method of claim 20, wherein the mixture of solvents comprises at least one co-solvent.

28. The method of claim 27, wherein the co-solvent comprises dipropylene glycol methyl ether.

29. The method of claim 27, wherein the weight ratio of the co-solvent to the dicarboxylic acid diester ranges from 5/50 to 30/70.

30. The method of claim 27, wherein the weight ratio of the co-solvent to the dicarboxylic acid diester ranges from 30/70 to 70/30.

31. The method of claim 27, wherein the weight ratio of the co-solvent to the dicarboxylic acid diester ranges from 70/30 to 50/5.

32. The method of claim 20, wherein group A comprises a group A_{MG} of formula ——CH(CH₃)CH₂CH₂—, a group A_{ES} of formula —CH(C₂H₅)CH₂—, a group —(CH₂)₄, or a mixture thereof.

33. The method of claim 20, wherein R¹ and R² comprise methyl groups.

34. The method of claim 20, wherein the composition comprises the non-ionic surfactant in an amount ranging from 0.05 to 5% by weight.

35. The method of claim 20, wherein the composition comprises the anionic surfactant in an amount ranging from 0.01 to 5% by weight.

36. The method of claim 20, wherein the composition comprises at most 10% by weight of water.

37. The method of claim 20, wherein, the composition comprises the dicarboxylic acid diester in an amount ranging from 60 to 80% by weight.

38. The method of claim 20, wherein the composition comprises the co-solvent in an amount ranging from 5 to 30% by weight.

39. The method of claim 20, wherein the composition, comprises:
the dicarboxylic acid diester in an amount ranging from 60 to 80% by weight;
a propylene glycol n-butyl ether solvent in an amount ranging from 5 to 30% by weight;
a mixture of surfactants in an amount ranging from 0.05 to 5% by weight,
wherein said mixture of surfactants comprises two castor oils, each with a different degree of polyethoxylation, and a polyalkoxylated alcohol;
a polyalkoxylated phosphate ester surfactant in salified or non-salified form, in an amount ranging from 0 to 5% by weight,
an acid in an amount ranging from 0 to 5% by weight, and
water in an amount ranging from 0 to 10% by weight.

40. The method of claim 20, wherein the composition comprises at least 60% by weight of the solvent or the mixture of solvents.

41. The method of claim 20, wherein the composition comprises the non-ionic surfactant in an amount ranging from 0.1% to 2.5% by weight.

42. The method of claim 41, wherein the composition comprises the non-ionic surfactant in an amount ranging from 0.1% to 2% by weight.

43. The method of claim 20, wherein the composition comprises the anionic surfactant in an amount ranging from 0.02% to 1% by weight.

44. The method of claim 43, wherein the composition comprises the anionic surfactant in an amount ranging from 0.03% to 0.99% by weight.
